(19) United States
(12) Patent Application Publication
(10) Pub. No.: US 2005/0067428 A1
(43) Pub. Date: Mar. 31, 2005

(54) Dispenser for tie wraps

(76) Inventors: Steven J. King, Old Saybrook, CT (US); Scott A. King, Durham, CT (US); Thomas Wenchell, Durham, CT (US)

Correspondence Address: EDWARDS & ANGELL, LLP, P.O. BOX 55874, BOSTON, MA, 02205, US

(21) Appl. No.: 10/896,631

(22) Filed: Jul. 22, 2004

Related U.S. Application Data
(60) Provisional application No. 60/489,758, filed on Jul. 24, 2003.

(51) Int. Cl. B21F 9/02; B21F 15/04; B21F 45/00; B21F 7/00; B23Q 7/12; B65H 9/00

(52) U.S. Cl. 221/171; 140/93.2

(57) ABSTRACT

A dispenser retains a plurality of elongated items such as tie wraps while permitting convenient, quick and easy access. The dispenser includes a housing that defines a chute. A strap attaches to the housing to enclose the chute and, in turn, retain the items. During removal of items, a holding tension is maintained on the remaining items. After emptying, the dispenser can be refilled and used repeatedly. A ball joint couples a mounting feature to the housing so that the dispenser can be mounted at a desirable location and adjusted to a desirable dispensing position.

### CROSS-REFERENCE TO RELATED APPLICATION

This application claims priority to U.S. Provisional Patent Application No. 60/489,758, filed Jul. 24, 2003, which is incorporated herein by reference.

### BACKGROUND OF THE INVENTION

1. Field of the Invention

The subject disclosure relates to devices for retaining elongated items, and more particularly to an improved device for dispensing cable ties or tie wraps.

2. Background of the Related Art

Tie wraps are widely used and well known in a variety of industries. For example, large quantities of tie wraps are utilized by electrical workers to secure wiring. Often the workers cannot conveniently carry enough tie wraps so one or more tie wraps are used to hold the desired quantity as a bundle. As tie wraps are removed from the bundle, the worker adjusts the tie wraps holding the bundle to maintain tension.

Several drawbacks exist with this practice of bundling. The bundle is too cumbersome to fit into the workers pocket and his hands need to be free to attend to his duties. If the worker removes too many tie wraps from the bundle without retensioning, the bundle can fall apart forcing the worker to reassemble the bundle. Eventually, so few tie wraps remain that the bundle will no longer remain in tact. Moreover, by utilizing tie wraps to hold the bundle, these tie wraps can no longer be used for their intended purpose and are discarded.

In view of the above, what is needed is a dispenser for tie wraps that maintains tension on the bundle without requiring adjustment. The dispenser would further be reusable, and easily accessed to free the worker.

### SUMMARY OF THE INVENTION

The present disclosure is directed to a device for dispensing elongated items including a housing defining a chute. A strap couples to the housing to variably enclose the chute for retaining a plurality of elongated items therein such that a holding tension is maintained on the elongated items as the elongated items are removed from the device.

The present disclosure is also directed to a dispenser for retaining a plurality of tie wraps including a housing defining a chute, a strap connected to the housing to enclose the chute and, in turn, retain the plurality of tie wraps therein and a ball joint assembly coupled to the housing so that an orientation of the housing and, thereby the plurality of tie wraps, can be adjusted.

Still another embodiment of the subject disclosure is directed to a dispenser for retaining a plurality of tie wraps including a housing defining a chute and a strap mechanism attached to the housing for maintaining a holding tension on the plurality of tie wraps such that the dispenser can be refilled.

It is an object of the subject disclosure to provide a dispenser that can be repeatedly used to retain a plurality of cable ties.

It is another object of the disclosure to allow mounting a dispenser in a desired location and adjusting the dispenser orientation to facilitate easy access to the retained items.

It should be appreciated that the present invention can be implemented and utilized in numerous ways, including without limitation as a process, an apparatus, a system, a device and a method for applications now known and later developed. These and other unique features of the devices disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings wherein:

FIG. 1 illustrates a front perspective view of a dispenser retaining a plurality of tie wraps in accordance with the present disclosure.

FIG. 2 illustrates a back perspective view of the dispenser of FIG. 1.

FIG. 3 illustrates a side view of the dispenser of FIG. 1 in an empty condition.

FIG. 4 illustrates a top view of the dispenser of FIG. 1 in an empty condition.

FIG. 5 illustrates an exploded view of the dispenser of FIG. 1.

FIG. 6 illustrates a front perspective view of another dispenser retaining a plurality of tie wraps in accordance with the present disclosure.

FIG. 7 illustrates a perspective view of the dispenser of FIG. 6 in an empty condition.

FIG. 8 illustrates a top view of the dispenser of FIG. 6.

FIG. 9 illustrates a back view of the dispenser of FIG. 6.

FIG. 10 illustrates a side view of the dispenser of FIG. 6 in the tilted position.

FIG. 11 illustrates an exploded view of the dispenser of FIG. 6.

FIG. 12 illustrates a perspective view of another dispenser for retaining a plurality of tie wraps in accordance with the present disclosure.

FIG. 13 illustrates a cross-sectional view of the dispenser of FIG. 12 in an empty condition.

FIG. 14 illustrates a cross-sectional view of the dispenser of FIG. 12 in a ready to load position.

FIG. 15 illustrates a plan view of a wire prior to assembly in the dispenser of FIG. 12.

FIG. 16 is an exploded view of another dispenser constructed in accordance with the subject disclosure, in particular this dispenser includes a housing with a coiled spring to maintain a force on the strap.

FIG. 17 is an exploded view of still another dispenser constructed in accordance with the subject disclosure, in particular this dispenser includes a housing with an off-center coiled spring to maintain a force on the strap.

### DETAILED DESCRIPTION OF PREFERRED EMBODIMENTS

The present invention overcomes many of the prior art problems associated with dispensers of elongated items. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

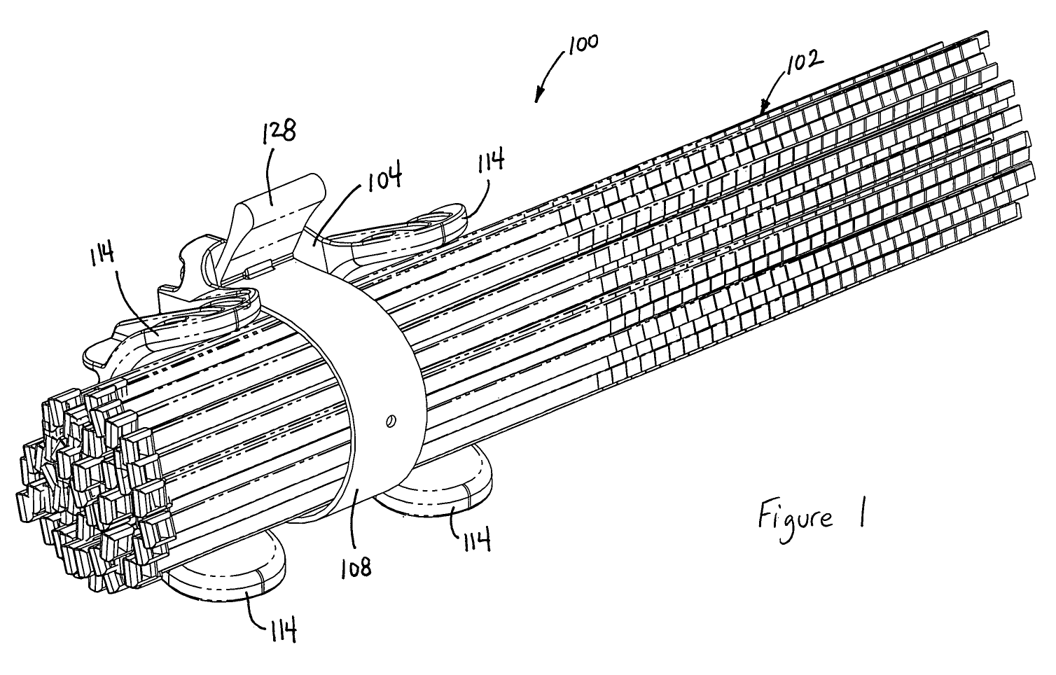

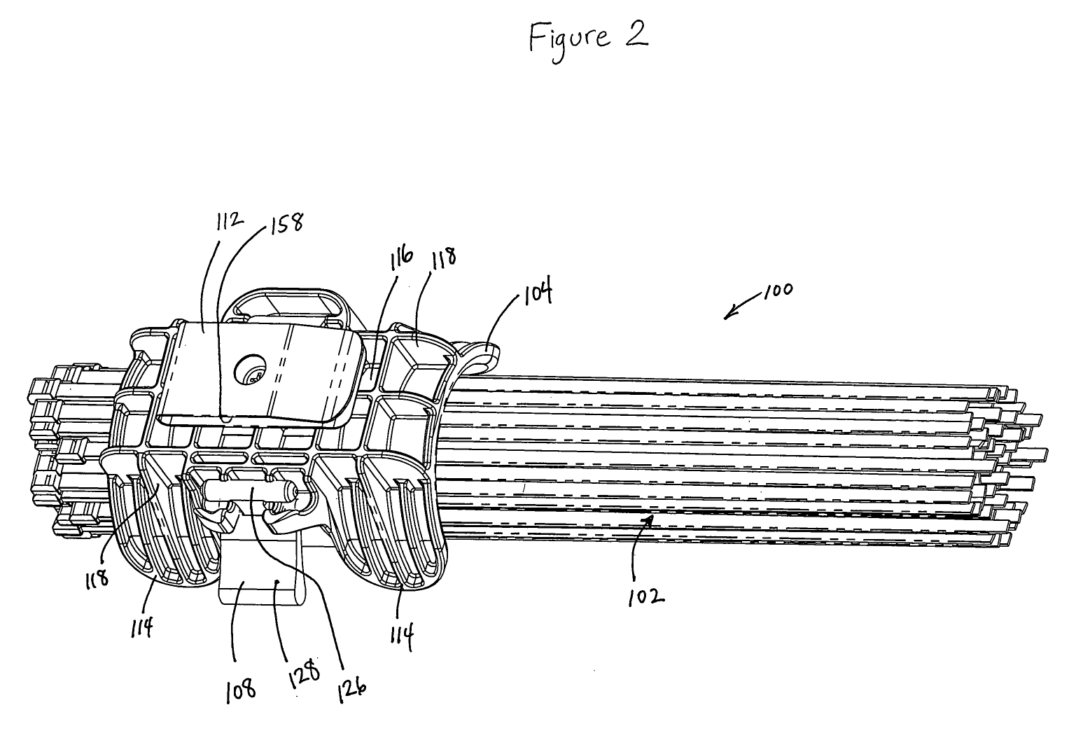

Referring to FIGS. 1 and 2, a dispenser 100 retains a plurality of tie wraps 102 while permitting convenient, quick and easy access. The dispenser 100 includes a housing 104 that defines a chute 106 (see FIG. 4). A strap 108 attaches to the housing 104 to enclose the chute 106 and, in turn, retain the plurality of tie wraps 102 therein. During removal of tie wraps 102 for use, a holding tension is maintained on the remaining tie wraps 102. After emptying, the dispenser 100 can be refilled and used repeatedly. A clip 112 couples to the housing 104 so that a worker can attach the dispenser 100 to a belt or other desirable location.

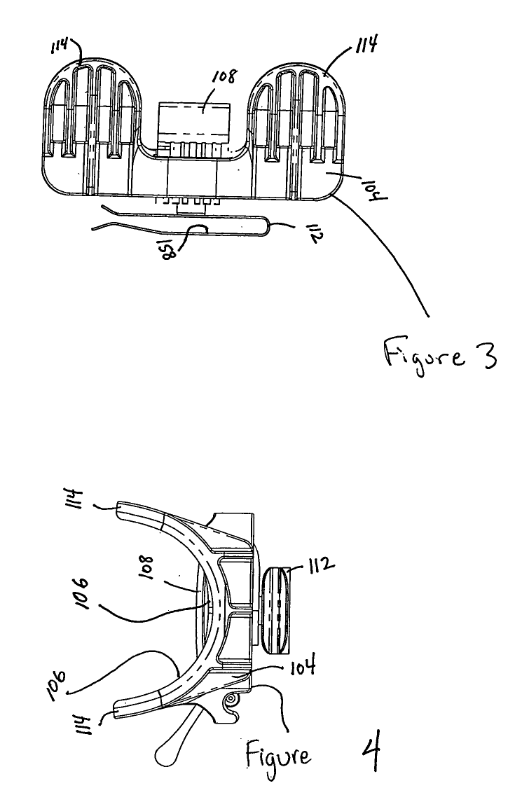

Referring also to FIGS. 3 and 4, the housing 104 has four curved projections 114 extending from a body portion 1 16 to form the chute 106. A lattice of stiffening ribs 118 on the outside of the housing 104 add structural integrity thereto. The housing 104 is preferably a plastic material, either rigid or flexible.

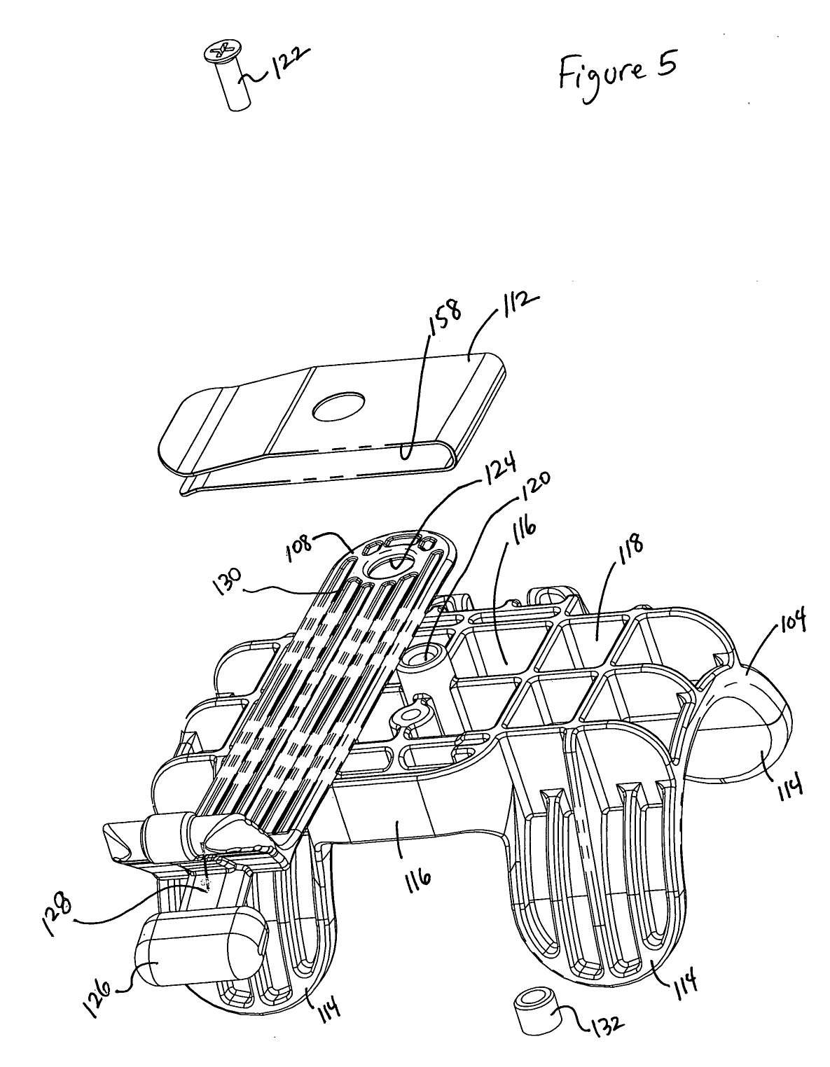

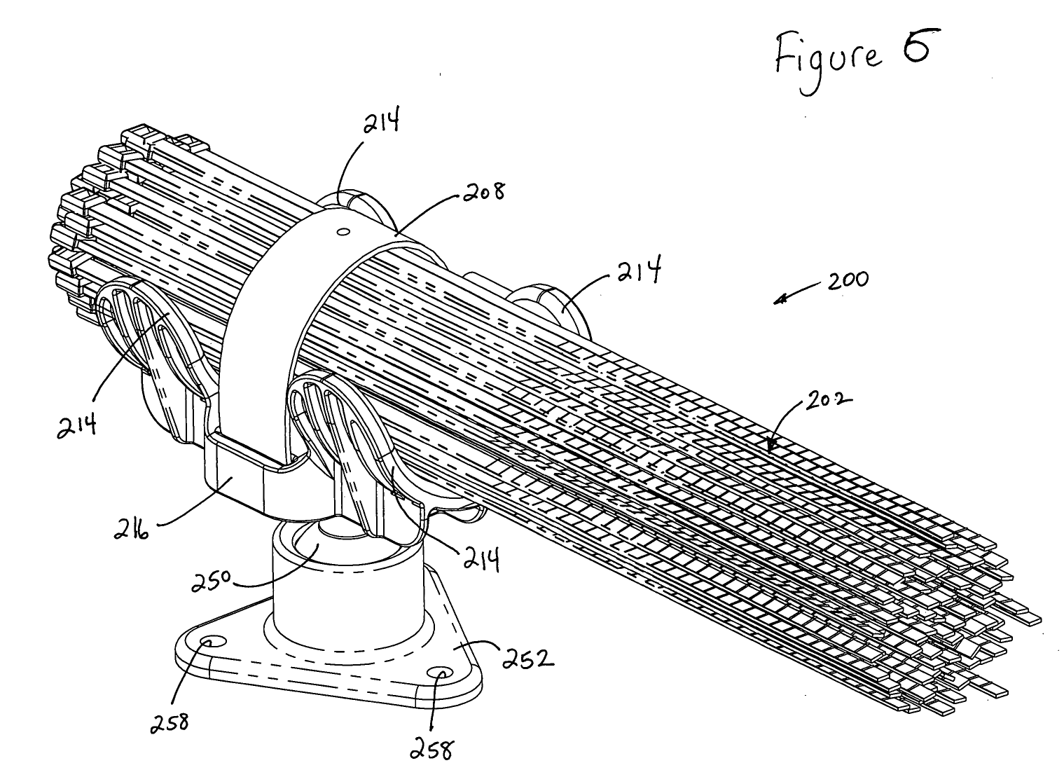

The strap 108 forms a hole 124 on one end for receiving a fastener 122 (see FIG. 5). On the other end, the strap 108 forms a latch 126 for coupling to the housing 104 and a tab 128 for releasing the latch 126 from the housing 104. Preferably, the latch 126 is T-shaped and selectively locks with a complimentary feature formed on the housing 104. It will be appreciated that the latch 126 may be any of numerous configurations that serve the intended purpose such as, without limitation, an I-shaped portion that is frictional engaged within a notch formed in the housing 104, the latch 126 may form a plurality of cavities for engaging corresponding protrusions formed on the housing 104, or the latch 126 may utilize hook and loop fabric. In still another embodiment, the strap 108 does not have a latch but is fixed to the housing 104 on both ends. Preferably, the strap 108 includes grooves 130 to provide additional frictional linking with the tie wraps 102. The strap 108 is preferably fabricated from isoprene polymer or a like elastic material. As a result, the strap 108 can be repeatably stretched but will return to an original shape.

Still referring to FIGS. 1-4, the clip 112 forms a deflectable slot 158 for coupling the dispenser 100 to a desired location. A bushing 127 allows for rotation of the clip 112 with respect to the housing 104. In another embodiment, a curved hook or like attachment feature is attached to the housing 104 for coupling the device 100 to a desired location. In another embodiment, a ball joint attaches the clip 112 to the housing 104 so that a worker can adjust the orientation of the dispenser 100. In still another embodiment, hook and loop fabric is utilized instead of a clip 112 so that the dispenser 100 can fixed in a desired location.

Referring now to FIG. 5, the dispenser 100 is shown in an exploded view. A throughhole 120 in the body portion 116 receives a fastener 122 for coupling the strap 108 and clip 112 to the housing 104. A nut 132 couples to the fastener 122 for retaining the fastener 122. Preferably, the nut 132 is a brass bushing that is press fit into the housing 104. When mounted to the housing 104 by the fastener, the strap 108 can enclose the chute 106 by engaging the latch 126 to the housing 104.

Referring to FIG. 4, the dispenser 100 is shown in an empty condition with the latch 126 coupled to the housing 104. As a result, the strap 108 is slightly tensioned across the chute 106 such that even a single tie wrap 102 would be retained therein. To load the dispenser 100, a worker may simply insert the desired quantity of tie wraps 102 into the chute 106. Alternatively, the worker can use the tab 128 to release the strap 108. Upon placing the tie wraps 102 within the chute 106, the latch 126 is pushed into frictional engagement with the housing 104 to retain the tie wraps 102. By using the clip 112, the worker can secure the dispenser 100 to a belt, pants, toolbox or like desired location. To remove one or more tie wraps 102, the tie wraps 102 are simply selected and slid out of the chute 106.

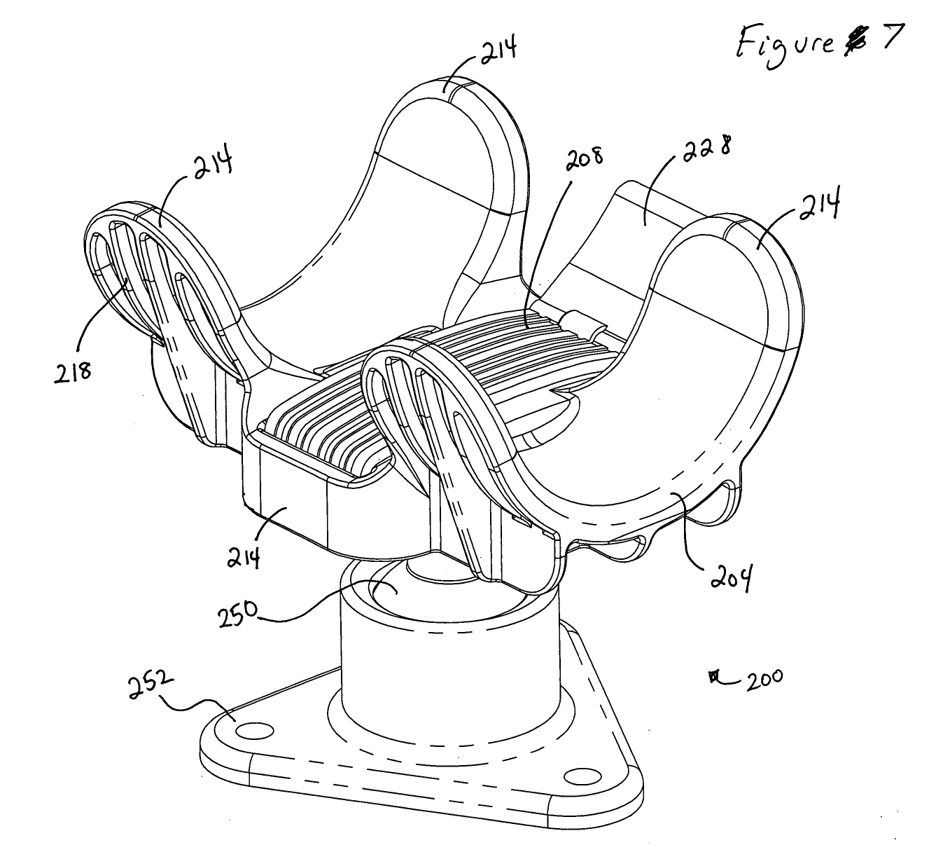

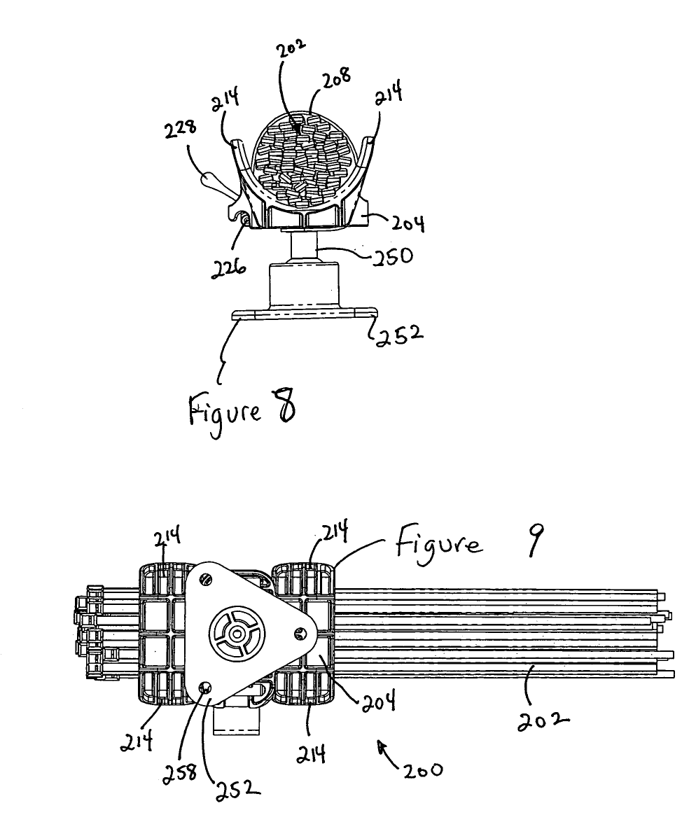

Referring to FIGS. 6- 10, another embodiment of a dispenser of the present disclosure is indicated generally by the reference numeral 200. The dispenser 200 is substantially the same as the dispenser 100 described above, and therefore like reference numerals preceded by the numeral “2” instead of the numeral “1” are used to indicate like elements whenever possible. The primary difference of the dispenser 200 in comparison to the dispenser 100 is that the dispenser 200 is designed to be fixed on a flat surface. A ball joint 250 couples a bracket 252 to the housing 204. The bracket 252 attaches the dispenser 200 to a reasonably flat surface or other desirable location with fasteners (not shown) and the ball joint 250 allows adjusting the orientation of the dispenser 200.

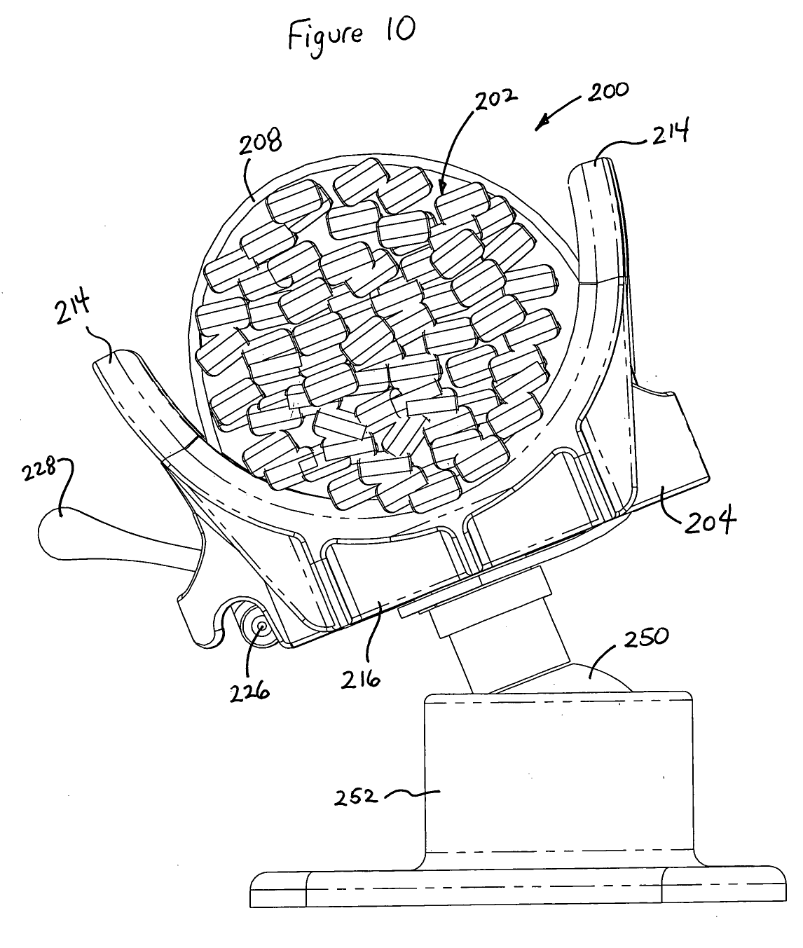

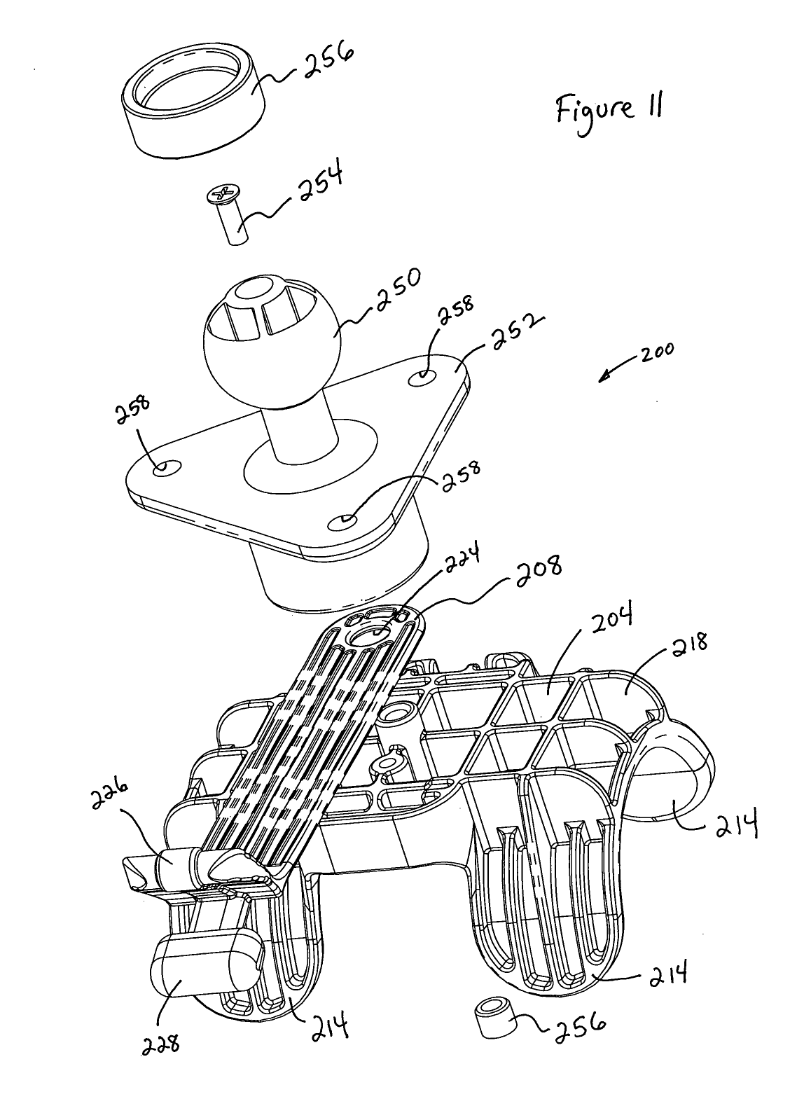

Referring now to FIG. 11, the dispenser 200 is shown in an exploded view. A fastener 254 passes through the ball joint 250, bracket 252 and housing 204 to threadably engage a nut 256. A locking ring 256 secures the ball joint 250 within the bracket 252. A friction force is generated between the ball 250 and bracket 252 so that a relative position of the housing 204 can be varied as seen in FIG. 10. Mounting holes 258 in the bracket 252 facilitate securing the dispenser 200 to the desired location.

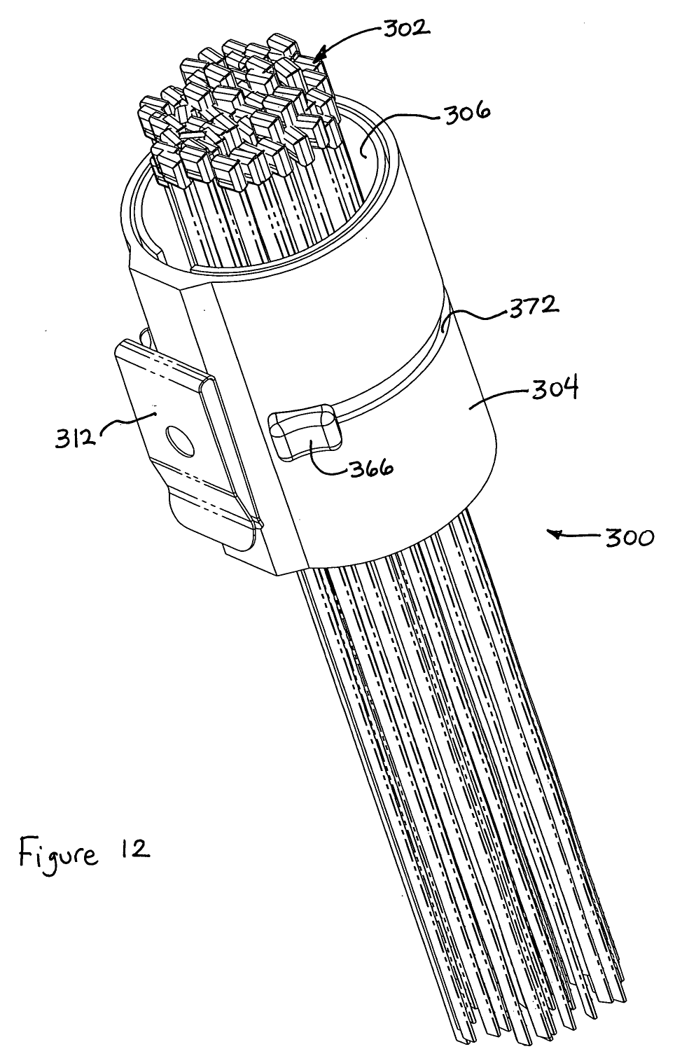

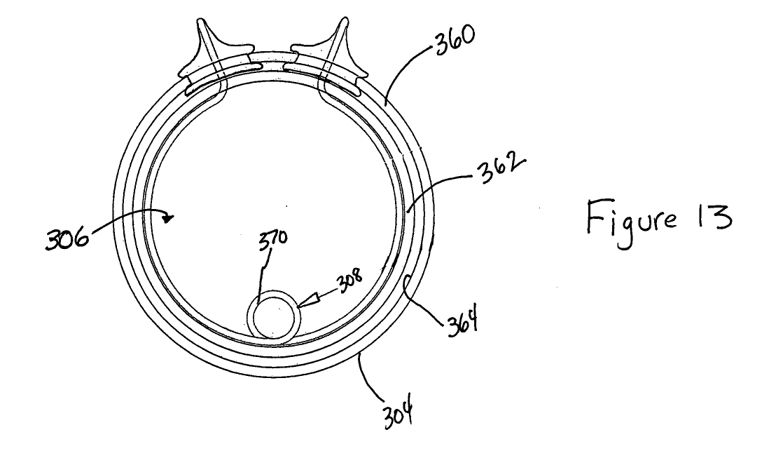

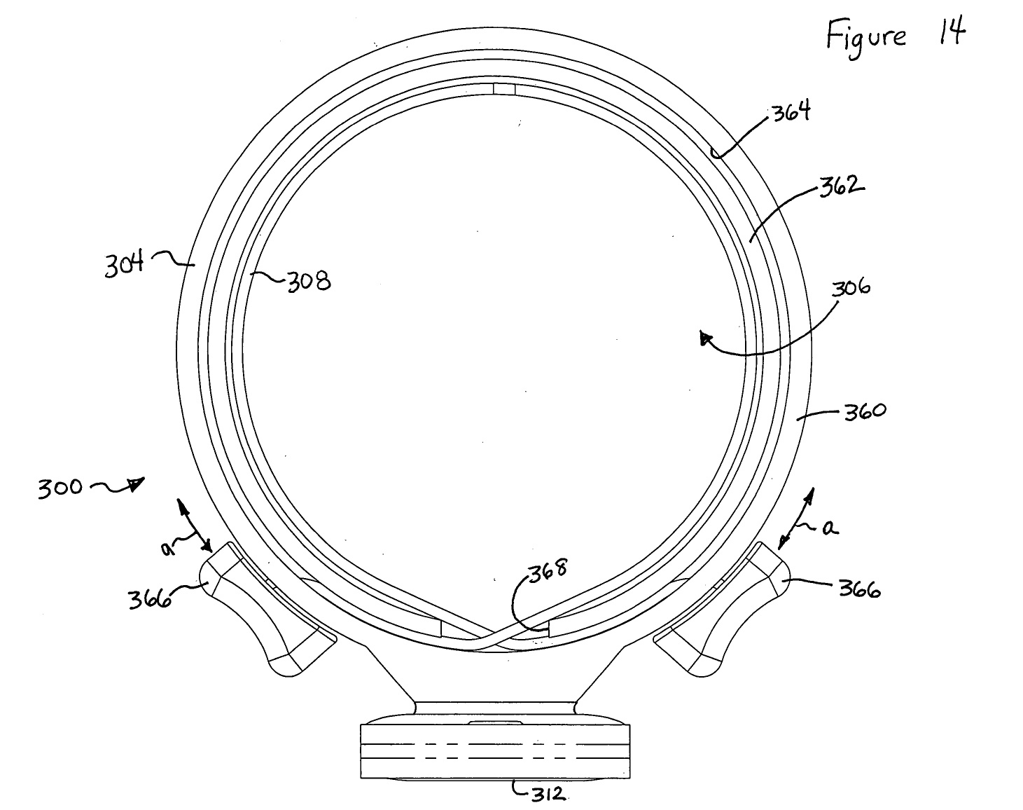

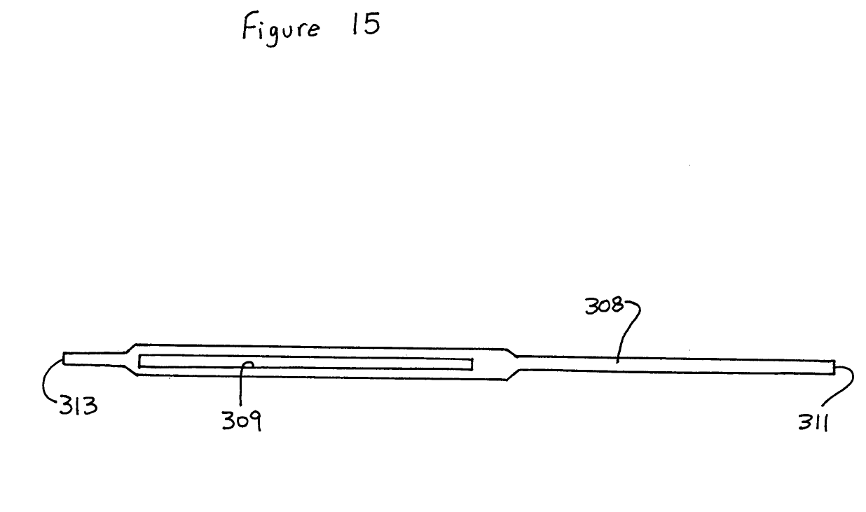

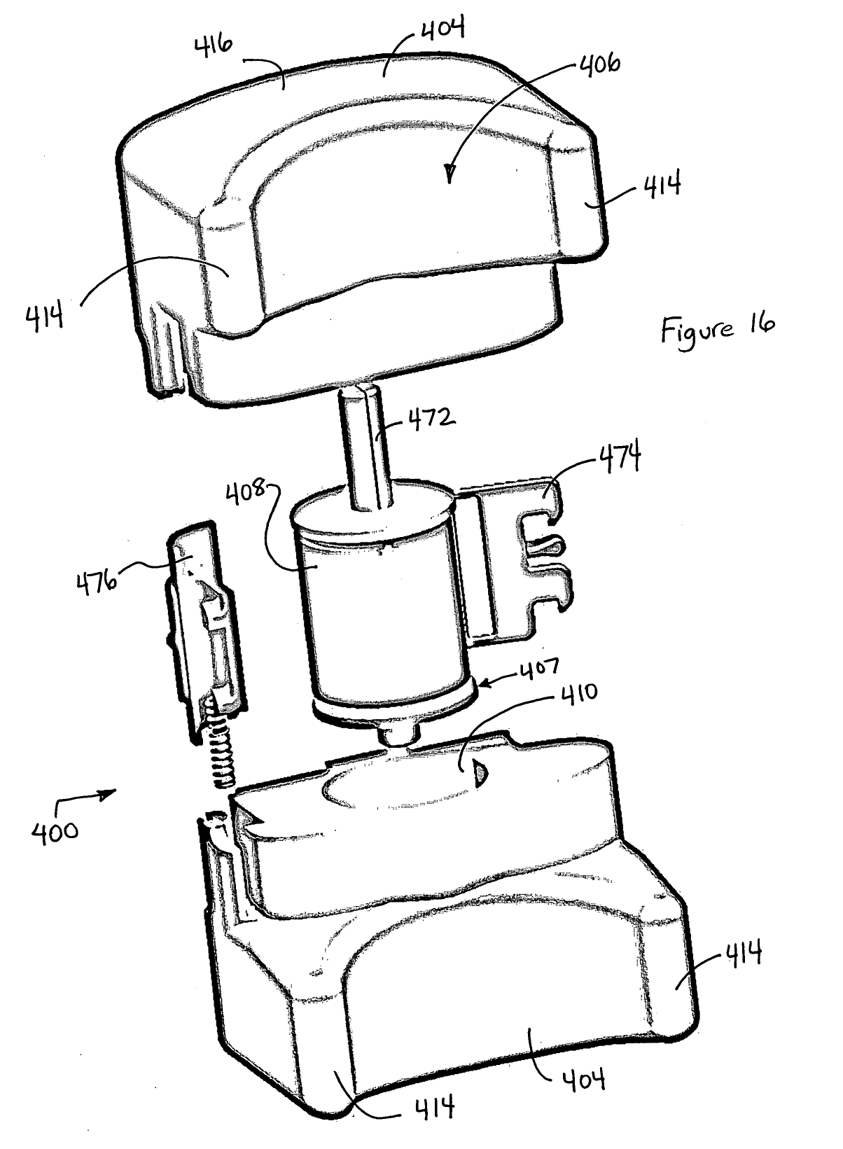

Referring now to FIGS. 12-15, as will be appreciated by those of ordinary skill in the pertinent art, still another dispenser 300 utilizes the same principles of the dispensers described above. Accordingly, like reference numerals preceded by the numeral “3” instead of the numerals “1” or “2”, are used to indicate like elements whenever possible. The dispenser 300 includes a housing 304 for retaining a wire 308 for frictionally holding a variable amount of tie wraps 302. As best seen in FIG. 15, the wire 308 forms an elongated slot 309 for receiving an end 311 of the wire 308 to create a variable loop 370 (see FIGS. 13 and 14). In a preferred embodiment, the wire 308 is preformed nitinol wire.

Referring now to FIG. 13, the dispenser 300 is shown in an empty condition from a top view. The housing 304 has an outer shell 360 and an inner shell 362. Preferably, the outer shell 360 and the inner shell 362 are integral at one or both ends. A slot 364 is formed between the outer shell 360 and the inner shell 362 for slidingly engaging a pair of levers 366. The levers 366 capture each end of the wire 308. An opening 368 in the inner shell 362 allows the loop 370 of wire 308 to extend within an interior of the housing 304. The levers 366 project outward of the housing 304 through a channel 372 formed in the outer shell 360 for helping a user position the levers 366 within the slot 372.

In another embodiment, the outer shell 360 does not have a slot and the ends of the wire 308 are retained therein. The housing 304 also includes a clip 312 for securing the dispenser 300 to a user. It is envisioned that the clip 312 can be any of a plurality of attachment mechanism, with or without flexible mounts, as would be appreciated by those of ordinary skill in the art.

Referring now to FIG. 14, the dispenser 300 is shown ready to receive a bundle of tie wraps. In order to obtain the loading position, a user pushes levers 366 along the direction of arrows “a”. As a result, the loop 370 expands in diameter until the loop 370 is limited by the inner shell 362 or the full range of travel of the levers 366 is reached. The tie wraps 302 can then be placed within the chute 306 where the loop 370 surrounds the tie wraps 302. When the levers 366 are released, the wire 308 begins to return to the shape as shown in FIG. 13 and, in turn, an inward radial force is generated to retain the tie wraps 302. To remove one or more tie wraps 302 from the dispenser 300, the user simply pulls the tie wraps 302 from the dispenser 300. As tie wraps 302 are removed, the loop 370 constricts further to retain the remaining tie wraps 302. Upon depletion of the dispenser 300, the loading process is repeated.

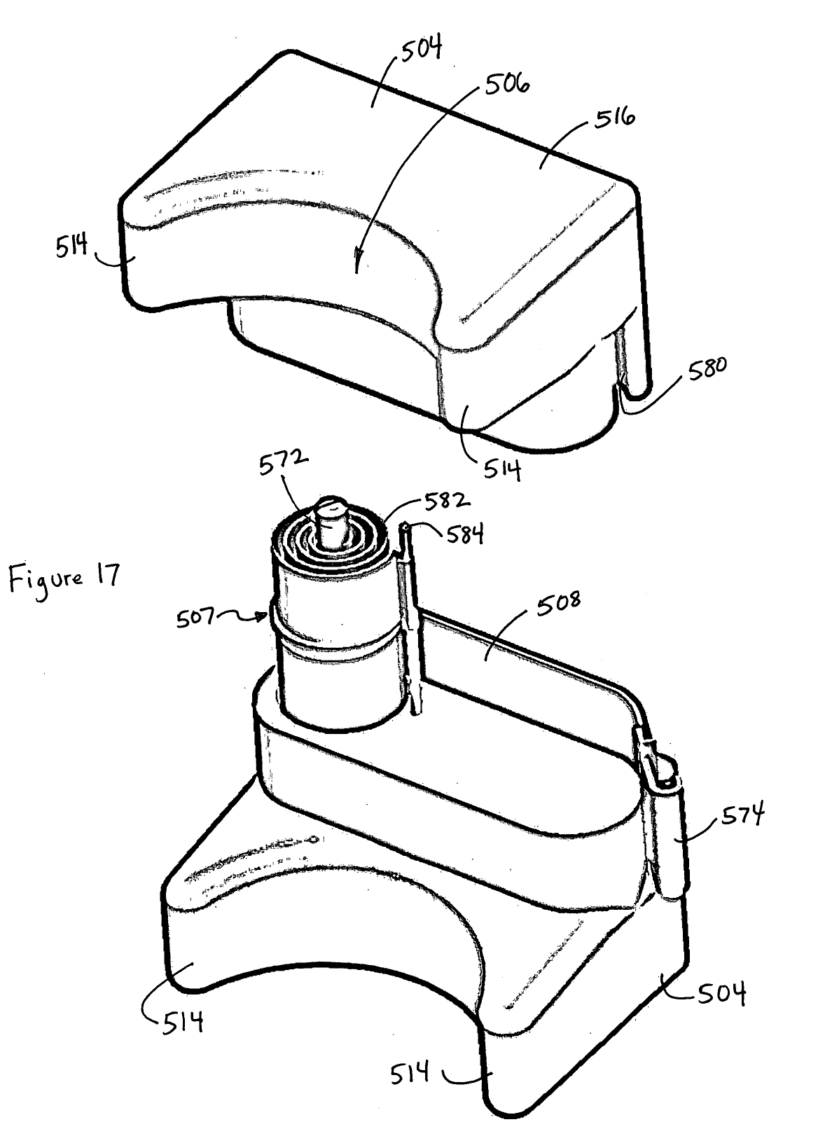

Referring to FIG. 16, another embodiment of a dispenser of the present disclosure is indicated generally by the reference numeral 400. The dispenser 400 is substantially similar to the dispensers described above, and therefore like reference numerals preceded by the numeral “4” instead of the numeral “1”, “2” or “3” are used to indicate like elements whenever possible. A difference of the dispenser 400 is that the dispenser 400 retains a strap mechanism 407 within a hollow 410 formed within the housing 404. The strap mechanism 407 includes a strap 408 wound around a pintle 470 for facilitating rotation of the strap mechanism 408 within the hollow 410. The strap 408 is part retracting coil (not shown) so that winding tension is maintained when the strap 408. Preferably, the strap also includes a fabric portion with an engagement clip 474 coupled to the unwound end. The housing 404 also includes a clip catch 476 for selectively capturing and releasing the engagement clip 474.

To load the dispenser 400, the tie wraps (not shown) are placed in the chute 406 and the strap 408 is stretched around the tie wraps and secured to the clip catch 476. The coil portion of the strap 408 winds down upon the chute 406 to retain the tie wraps thereto. As tie wraps are removed from the housing 404, the strap 408 continues to rewind about the pintle 470 to maintain retaining tension. Upon depletion, the engagement clip 474 is released from the clip catch 476 and the loading process is repeated.

Referring to FIG. 17, another embodiment of a dispenser of the present disclosure is indicated generally by the reference numeral 500. The dispenser 500 is shown in a paritally exploded view. The dispenser 500 is substantially the same as the dispenser 400 described above, and therefore like reference numerals preceded by the numeral “5” instead of the numeral “4” are used to indicate like elements whenever possible. The primary difference of the dispenser 500 in comparison to the dispenser 400 is that the strap mechanism 507 is not centrally located within the housing 504.

Another difference is that the engagement clip 474 is c-shaped for latching onto a complimentary structure, such as a notch (not shown), formed in the housing 504. The strap 508 is connected directly to a lower portion of the pintle 572. A coil portion 582 is secured between a post 584 and the pintle 572 to maintain a retracting tension upon the pintle 572 and, thereby, the strap 508. In operation, the strap 508 passes through a slot 580 formed in the housing 504 and maintains the tie wraps (not shown) taught against the chute 506 by a retracting tension provided by the coil portion 582.

While the invention has been described with respect to preferred embodiments, those skilled in the art will readily appreciate that various changes and/or modifications can be made to the invention without departing from the spirit or scope of the invention as defined by the appended claims. For example, without limitation, it is envisioned that the dispenser may be utilized for retaining a variety of items such as tools, pencils, nails, lengths of wire, lengths of rope, and combinations thereof. For another example, the dispenser does not include an attachment feature but, rather, the strap is permanently fixed to the housing on each end.

1. A device for dispensing elongated items comprising:
a housing defining a chute; and
a strap coupled to the housing to variably enclose the chute for retaining a plurality of elongated items therein such that a holding tension is maintained on the elongated items as the elongated items are removed from the device.

2. A device as recited in claim 1, further comprising a ball joint assembly coupled to the housing so that an orientation of the housing and, thereby the plurality of elongated items, can be adjusted.

3. A device as recited in claim 2, further comprising a clip coupled to the ball joint assembly.

4. A device as recited in claim 2, further comprising a mounting bracket coupled to the ball joint assembly.

5. A device as recited in claim 1, wherein the strap is a wire fit within a slot in the housing to form a variable loop.

6. A device as recited in claim 1, wherein the housing has an outer shell and an inner shell.

7. A device as recited in claim 6, wherein the outer shell and the inner shell are integral.

8. A device as recited in claim 6, wherein the outer shell and the inner shell define a slot for slidingly engaging a pair of levers, each lever capturing an end of the wire.

9. A device as recited in claim 6, wherein an opening formed in the inner shell allows the variable loop of wire to extend within an interior of the housing such that the variable loop expands in diameter to load the elongated items and constricts to generate an inward radial force for retaining the elongated items.

10. A dispenser for retaining a plurality of tie wraps comprising:
a housing defining a chute;
a strap connected to the housing to enclose the chute and, in turn, retain the plurality of tie wraps therein; and
a ball joint assembly coupled to the housing so that an orientation of the housing and, thereby the plurality of tie wraps, can be adjusted.

11-13. (canceled)

14. A dispenser as recited in claim 10, wherein the housing has a body portion with four curved projections extending therefrom to form the chute.

15. A dispenser for retaining a plurality of tie wraps comprising:
a housing defining a chute;
a strap mechanism attached to the housing for maintaining a holding tension on the plurality of tie wraps such that the dispenser can be refilled.

16. A dispenser as recited in claim 15, further comprising a clip coupled to the housing so that the dispenser attaches to a desirable location.

17. (canceled)

18. A dispenser as recited in claim 15, further comprising four curved projections extending from a body portion of the housing to form the chute.

19. (canceled)

20. A dispenser as recited in claim 15, wherein the strap mechanism is a wire defining an elongated slot for receiving an end of the wire to create a variable loop, the wire being placed within a slot formed in the housing such that the variable loop is within the chute.

21. (canceled)

22. A dispenser as recited in claim 15, wherein the strap mechanism is a neoprene band secured to the housing.

23-38. (canceled)

39. A dispenser for holding tie wraps comprising:
a length of wire; and
a housing defining a slot for slidably receiving a portion of the length, wherein the length forms an expandable circle within the housing for receiving a plurality of tie wraps such that a holding tension is maintained as tie wraps are removed.

40. A dispenser as recited in claim 39, further comprising first and second levers attached to ends of the length for facilitating loading the plurality of tie wraps.

41. (canceled)

42. A dispenser as recited in claim 39, wherein the length of wire forms an elongated slot.

43. A dispenser as recited in claim 39, further comprising a clip on the housing for attaching the dispenser to a belt.

44-48. (canceled)
